(19) United States
(12) Patent Application Publication
(10) Pub. No.: US 2011/0181545 A1
(43) Pub. Date: Jul. 28, 2011

(54) SENSOR ELEMENT AND DISPLAY APPARATUS

(75) Inventors: Naohiro Takahashi, Tokyo (JP); Satoshi Terui, Miyagi (JP); Masato Ishigaki, Miyagi (JP); Katsunori Sato, Miyagi (JP); Hidetoshi Honda, Miyagi (JP)

(73) Assignee: SONY CORPORATION, Tokyo (JP)

(21) Appl. No.: 13/009,434

(22) Filed: Jan. 19, 2011

(30) Foreign Application Priority Data
Jan. 26, 2010 (JP) P2010-014116

(51) Int. Cl. G06F 3/044

(52) U.S. Cl. 345/174

(57) ABSTRACT

A sensor element is provided that includes a flexible transparent base material, a first conductive pattern, and a second conductive pattern. The flexible transparent base material has a first surface and a second surface opposite to the first surface. The first conductive pattern is configured to electrostatically detect an operation position of an input operator in a first direction, the first conductive pattern being formed on the first surface. The second conductive pattern is configured to electrostatically detect an operation position of the input operator in a second direction different from the first direction, the second conductive pattern being formed on the second surface.

### CROSS REFERENCES TO RELATED APPLICATIONS

The present application claims priority to Japanese Patent Application JP 2010-014116 filed on Jan. 26, 2010, the entire contents of which is hereby incorporated by reference.

### BACKGROUND

The present disclosure relates to a sensor element capable of being used for a capacitance type touch panel and to a display apparatus provided with the same.

In recent years, a touch panel is being used as an input device for an information processing terminal by being layered on a display panel, for example. As a capacitance type touch panel, for example, Japanese Patent Application Laid-open No. 2008-152640 (paragraph 0026, FIG. 2) discloses a touch panel having an upper transparent film, a lower transparent film, and a transparent adhesive. The upper transparent film has a transparent conductive film pattern formed in a longitudinal direction. The lower transparent film has a transparent conductive film pattern formed in a traverse direction. The transparent adhesive bonds the upper and lower transparent films to each other. The touch panel further includes a flexible wiring board for electrically connecting the transparent conductive film patterns to an external controller. The flexible wiring board is connected to the transparent conductive film patterns so as to be sandwiched between the upper and lower transparent films.

### SUMMARY

In recent years, reductions in thickness and weight of an information processing terminal are being promoted. Along with the reductions, a reduction in thickness of a touch panel is being demanded. However, a touch panel in related art has the structure in which two transparent films having transparent conductive film patterns formed thereon are bonded to each other as described above, which makes the reduction in thickness difficult. In addition, a task for bonding the transparent films has to be executed with high alignment accuracy, which hinders improvement in productivity.

Meanwhile, to reduce the thickness of a touch panel, a reduction in thickness of individual transparent films is conceivable. However, as a transparent film becomes thinner, the handleability thereof is reduced, which makes it difficult to ensure desired alignment accuracy at a time of bonding. Further, the structure in which a wiring board for external connection is sandwiched between transparent films may cause a local curvature or deformation of a surface of a touch panel, with the result that the visibility of a display image may be lowered.

In view of the above-mentioned circumstances, it is desirable to provide a sensor element capable of realizing a reduction in thickness and improving productivity, and a display apparatus provided with the sensor element.

According to an embodiment, there is provided a sensor element including a flexible transparent base material, a first conductive pattern, and a second conductive pattern.

The transparent base material has a first surface and a second surface opposite to the first surface.

The first conductive pattern is for electrostatically detecting an operation position of an input operator in a first direction, and is formed on the first surface.

The second conductive pattern is for electrostatically detecting an operation position of the input operator in a second direction different from the first direction, and is formed on the second surface.

The sensor element has the structure in which the first conductive pattern and the second conductive pattern are supported by the common transparent base material, and accordingly the thickness of the element can be reduced as compared to the structure in which two base materials on each of which a conductive pattern is formed are bonded to each other. Accordingly, it is possible to realize a reduction in thickness of the sensor element. Further, according to the sensor element described above, the step of bonding two base materials becomes unnecessary, with the result that it is possible to reduce man-hours for production and improve the productivity. In addition, according to the sensor element described above, it is possible to do away with the structure in which a wiring substrate for electrically connecting transparent conductive patterns to the outside is sandwiched between the base materials. Therefore, it is possible to prevent a local curvature or deformation of the transparent base materials from being caused by the sandwiching of the wiring substrate.

The first conductive pattern may include a plurality of first transparent electrode portions that are extended in the second direction and arranged in the first direction. In this case, the second conductive pattern includes a plurality of second transparent electrode portions that are extended in the first direction and arranged in the second direction.

With this structure, an operation position can be detected based on a change in capacitance between the input operator and the first and second transparent electrode portions at an operation position of the input operator, or a change in capacitance between the first and second transparent electrode portions at an operation position of the input operator.

The sensor element may further include a first wiring substrate and a second wiring substrate.

The first wiring substrate is attached to the first surface and includes a first terminal group electrically connected to the first conductive pattern.

The second wiring substrate is attached to the second surface and includes a second terminal group electrically connected to the second conductive pattern.

With this structure, the wiring substrates can be connected while a local curvature or deformation is not caused on the first surface and the second surface of the transparent base material. The first and second wiring substrates may be attached to the transparent base material so as to overlap each other when viewed from a direction perpendicular to the first surface (second surface), or may be attached so as not to overlap each other.

The sensor element may further include a conductor portion, an interlayer connection portion, and a wiring substrate.

The conductor portion is formed on the first surface. The interlayer connection portion passes through the base material to connect the conductor portion and the second conductive pattern. The wiring substrate is attached to the first surface and includes a first terminal group electrically connected to the first conductive pattern and a second terminal group electrically connected to the conductor portion.

With this structure, the first and second conductive patterns are connected to the common wiring substrate, with the result that it is possible to reduce the number of components and to further reduce a thickness of the element. Further, also with the structure described above, the wiring substrates can be connected while a local curvature or deformation is not caused on the first surface and the second surface of the transparent base material.

According to another embodiment, there is provided a display apparatus including a display panel and a sensor element.

The display panel has a display surface on which an image is displayed.

The sensor element includes a flexible transparent base material, a first conductive pattern, and a second conductive pattern. The transparent base material has a first surface and a second surface opposite to the first surface. The first conductive pattern is for electrostatically detecting an operation position of an input operator in a first direction, and is formed on the first surface. The second conductive pattern is for electrostatically detecting an operation position of the input operator in a second direction different from the first direction, and is formed on the second surface. The sensor element is laminated on the display panel such that the second surface and the display surface are opposed to each other.

According to the display apparatus, the thickness of the sensor element can be reduced and thus a reduction in thickness of the display apparatus can be achieved. Further, it is possible to do away with the structure in which a wiring substrate for electrically connecting the sensor element to the outside is sandwiched between the base materials. Therefore, it is possible to prevent a local curvature or deformation of the sensor element from being caused by the sandwiching of the wiring substrate. Accordingly, it is possible to avoid the lowering of the visibility of a display image.

The display apparatus may further include a transparent substrate. The transparent substrate is laminated on the first surface of the sensor element and forms an operation surface on which an input operation is made with the input operator.

With the transparent substrate, the sensor element can be protected, and the flatness of the sensor element can be maintained and the operability can be prevented from being lowered at the same time.

According to the embodiments, it is possible to realize a reduction in thickness of a sensor element and a display apparatus including the sensor element. Further, it is possible to improve the productivity of the sensor element.

These and other objects, features and advantages will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a partial cross-sectional view schematically showing a structure of a display apparatus including a touch panel according to a first embodiment;

FIG. 2 is an exploded perspective view showing a structure of the touch panel;

FIG. 3 is a partial cross-sectional view schematically showing a structure of a display apparatus including a touch panel according to a comparative example;

FIG. 4 is a partial cross-sectional view schematically showing a structure of a display apparatus including a touch panel according to a second embodiment;

FIG. 5 is a partial cross-sectional view showing a layer structure of a touch panel according to a third embodiment;

FIG. 6 are schematic views for comparing structures of two types of touch panel samples each including optical adjustment layers shown in FIG. 5;

FIG. 7 is a diagram showing experimental results showing transmittance characteristics of the two types of samples shown in FIGS. 6;

FIG. 8 are schematic views for comparing structures of other two types of touch panel samples each including the optical adjustment layers shown in FIG. 5;

FIG. 9 is a diagram showing experimental results showing transmittance characteristics of the two types of samples shown in FIGS. 8;

FIG. 10 is a partial cross-sectional view schematically showing a modified example of the touch panel shown in FIG. 1;

FIG. 11 is a partial cross-sectional view schematically showing a modified example of the touch panel shown in FIG. 1; and

FIG. 12 is a partial cross-sectional view schematically showing a modified example of the touch panel shown in FIG. 1.

### DETAILED DESCRIPTION

Hereinafter, embodiments will be described with reference to the drawings.

### FIRST EMBODIMENT

Structure of Display Apparatus

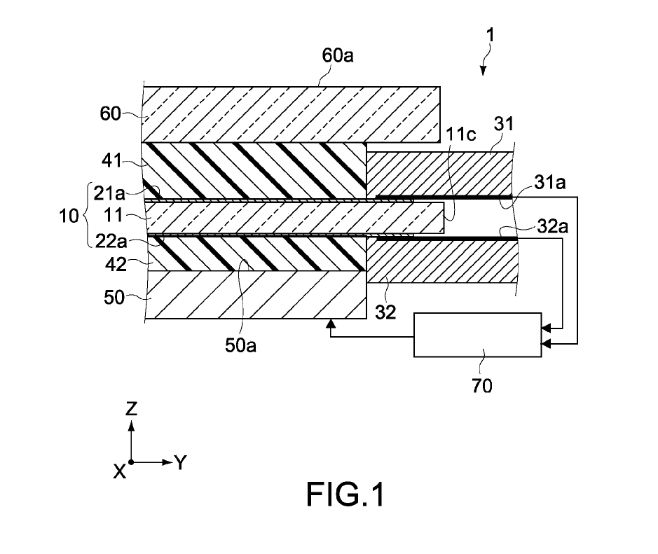

FIG. 1 is a schematic cross-sectional view showing a display apparatus according to a first embodiment. A display apparatus 1 of this embodiment is provided with a display panel 50, a touch panel 10 laminated on the display panel 50, a top plate 60 laminated on the touch panel 10, a control unit 70, a casing (not shown) that contains those components, and the like. In FIG. 1, an X-axis direction and a Y-axis direction indicate horizontal directions that are orthogonal to each other, and a Z-axis direction indicates a thickness direction of the display apparatus 1 that is orthogonal to each of the X-axis direction and the Y-axis direction.

The display apparatus 1 of this embodiment forms a display unit of an electronic apparatus such as a portable game machine, a mobile information terminal such as a mobile phone, and a laptop personal computer. In addition, the display apparatus 1 of this embodiment may be applied to a display unit of an electronic apparatus such as an installation type personal computer, an automatic teller machine of a financial institution, and an automatic ticketing machine of transportation.

Display Panel

The display panel 50 has a display surface 50a formed of a liquid crystal display, an organic EL (electroluminescence) display, or the like. A display of an image on the display panel 50 is controlled by the control unit 70.

Touch Panel

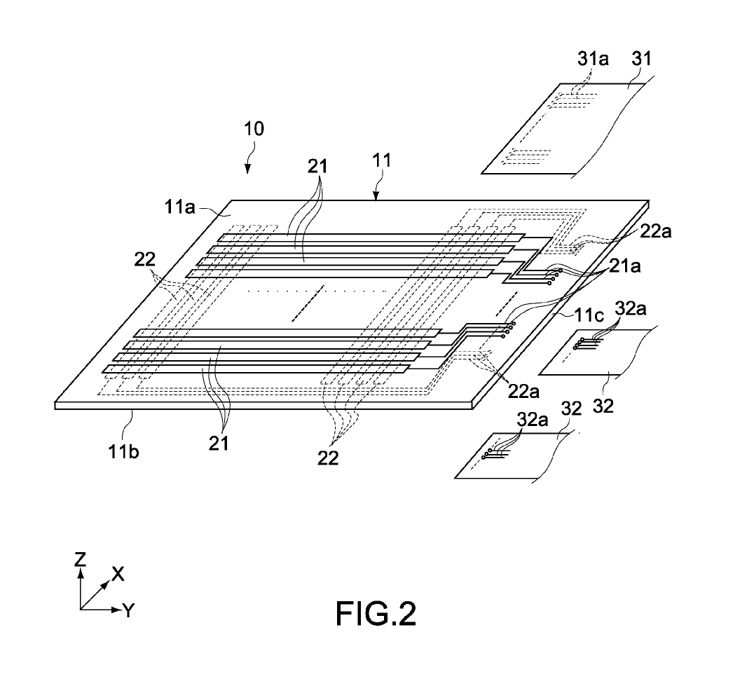

FIG. 2 is an exploded perspective view showing a structure of the touch panel 10. The touch panel 10 forms a sensor element for electrostatically detecting an operation position of an input operator that is operated for input to an upper surface of the top plate 60. In other words, the touch panel 10 includes a transparent base material 11, first transparent electrode portions 21 formed on a front surface 11a (first surface) of the transparent base material 11, and second transparent electrode portions 22 formed on a back surface 1 lb (second surface) of the transparent base material 11.

The transparent base material 11 is formed of, for example, a single-layer plastic film that is optically clear and has flexibility and electrical insulation property, such as polyethylene terephthalate (PET), polyethylene naphthalate (PEN), polycarbonate (PC), and polyimide (PI). The transparent base material is not limited to be colorless and transparent, and may be colored in an appropriate color.

The thickness of the transparent base material 11 is not particularly limited, but the thickness can be set to 100 μm or less from the viewpoint of achievement of a reduction in thickness of the touch panel 10, for example, to 50 μm or less. In this embodiment, a PET film having a thickness of 25 μm is used as the transparent base material 11.

The first and second transparent electrode portions 21 and 22 are formed of ITO (indium tin oxide), but in addition thereto, the first and second transparent electrode portions 21 and 22 may be formed of other transparent conductive oxide material such as SnO, ZnO, IZO (indium zinc oxide), and AZO (aluminum zinc oxide). The thickness of the first and second transparent electrode portions 21 and 22 is not particularly limited, and is 40 nm or less, for example. The first and second transparent electrode portions 21 and 22 are formed by patterning ITO films formed on both the surfaces of the transparent base material 11 in advance into predetermined shapes by etching processing, laser processing, or the like. It should be noted that in addition to the above method, the transparent electrode portions described above may be formed by forming a conductive paste material on the transparent base material 11 by, for example, screen printing.

The first transparent electrode portions 21 each have a strip-like shape extending in the Y-axis direction, and are formed on the front surface 11a of the transparent base material 11 at a predetermined pitch along the X-axis direction. The second transparent electrode portions 22 each have a strip-like shape extending in the X-axis direction, and are formed on the back surface 11b of the transparent base material 11 at a predetermined pitch along the Y-axis direction. The shape of the first and second transparent electrode portions 21 and 22 is not limited to the strip-like shape, and may be, for example, formed by connecting rhombic shapes in the extending directions. Those first and second transparent electrode portions 21 and 22 are formed in a predetermined area of the transparent base material 11 on an XY plane. The predetermined area includes, for example, a display area of an image on the display panel 50.

Next, on the front surface 11a of the transparent base material 11, a first wire group 21a electrically connected to the first transparent electrode portions 21 is formed. The first wire group 21a is drawn from each of the first transparent electrode portions 21 toward a peripheral portion 11c of the transparent base material 11, and end portions of the respective wires are aligned on the front surface 11a along the peripheral portion 11c. Similarly, on the back surface 11b of the transparent base material 11, a second wire group 22a electrically connected to the second transparent electrode portions 22 is formed. The second wire group 22a is drawn from each of the second transparent electrode portions 22 toward the peripheral portion 11c of the transparent base material 11, and end portions of the respective wires are aligned on the back surface 11b along the peripheral portion 11c. The first and second wire groups 21a and 22a are each formed of a print of a conductive paste such as an Ag (silver) paste.

As described above, the conductive patterns each having the predetermined shape are formed on the front surface 11a and the back surface 11b of the transparent base material 11. Here, the first transparent electrode portions 21 and the first wire group 21 a correspond to a “first conductive pattern”, and the second transparent electrode portions 22 and the second wire group 22a correspond to a “second conductive pattern”.

The touch panel 10 further includes first and second wiring substrates 31 and 32 (wiring members) for electrically connecting the first and second conductive patterns described above to the outside of the touch panel 10. In this embodiment, the touch panel 10 is connected to the control unit 70 of the display apparatus 1 via the first and second wiring substrates 31 and 32.

The first and second wiring substrates 31 and 32 are each formed of a flexible wiring board. The first wiring substrate 31 includes a first terminal group 31a electrically connected to the end portions of the first wire group 21a, and is connected to the peripheral portion 11c of the transparent base material 11 on the front surface 11a side. The second wiring substrate 32 includes a second terminal group 32a electrically connected to the end portions of the second wire group 22a, and is connected to the peripheral portion 11c of the transparent base material 11 on the back surface 11b side. In this embodiment, the second wiring substrate 32 is constituted of two wiring substrates, but the second wiring substrate is not limited thereto and may be constituted of one wiring substrate as in the case of the first wiring substrate 31.

The connection form of the transparent base material 11 and the first and second wiring substrates 31 and 32 is not particularly limited. For example, the transparent base material 11 and the first and second wiring substrates 31 and 32 are connected to each other via an anisotropic conductive film (ACF). Further, the first and second wiring substrates 31 and 32 may be simultaneously connected to the front and back surfaces 11a and 11b of the transparent base material 11, respectively, or individually connected thereto. In addition, the first and second wiring substrates 31 and 32 may be attached to the transparent base material 11 so as to overlap each other when viewed in the thickness direction (Z-axis direction), or may be attached so as not to overlap each other.

The touch panel 10 formed as described above is arranged between the top plate 60 and the display panel 50. The touch panel 10 is laminated on the display panel 50 via a transparent pressure-sensitive adhesive 42 such that the back surface 11b of the transparent base material 11 faces the display surface 50a. In addition, the top plate 60 is laminated on the front surface 11a of the touch panel 10 (transparent base material 11) via a transparent pressure-sensitive adhesive 41.

The transparent pressure-sensitive adhesives 41 and 42 are each formed of an optically-clear adhesive (OCA). As the transparent pressure-sensitive adhesives 41 and 42, a pressure-sensitive adhesive sheet is typically used. In addition thereto, as the transparent pressure-sensitive adhesives 41 and 42, an ultraviolet curable resin or the like may be used. Although the thickness of the transparent pressure-sensitive adhesives 41 and 42 is not particularly limited, the thickness is set to 100 μm or less, for example, 50 μm in this embodiment. Particularly in this embodiment, the thickness of the transparent pressure-sensitive adhesive 41 is made larger than that of the first wiring substrate 31. Accordingly, the interference between the top plate 60 and the first wiring substrate 31 can be avoided.

Top Plate

The top plate 60 (transparent substrate) covers the touch panel 10, and a surface thereof forms a flat input operation surface 60a that receives input operations made by the input operator. Examples of the input operator include various styluses in addition to a finger or hand of a user. The top plate 60 has a function of protecting the touch panel 10, and also has a function of maintaining the flatness of the touch panel 10 and avoiding the lowering of the input operability.

The top plate 60 is formed of, for example, a plastic film, a plastic sheet, or a plastic plate that is optically clear and has flexibility, such as polyethylene terephthalate (PET), polyethylene naphthalate (PEN), polycarbonate (PC), polyimide (PI), and polymethylmethacrylate (PMMA). The top plate is not limited to be colorless and transparent, and may be colored in an appropriate color. In addition, the input operation surface 60a may be subjected to treatment for improving the operability of the input operator, such as formation of a lubricating layer or a hard coat layer.

Though not particularly limited, the thickness of the top plate 60 is set to a thickness with which an adequate rigidity capable of maintaining the flatness of the touch panel 10 is obtained, and is, for example, 100 μm or more and 1.5 mm or less. In this embodiment, the top plate 60 is formed of a polycarbonate resin having a thickness of 1 mm.

Control Unit

The control unit 70 performs image display control with respect to the display panel 50, and detection control of an operator with respect to the touch panel 10. The control unit 70 may be constituted of a part of a control section of an electronic apparatus including the display apparatus 1.

The control unit 70 supplies an image signal to the display panel 50 so that an image is displayed on the display surface 50a. For example, the control unit 70 supplies, in association with the touch panel 10, an image signal for prompting a user to make an input operation to the touch panel 10, and an image signal created based on the input operation made to the touch panel 10, to the display panel 50.

The input-operator detection method by the control unit 70 is not particularly limited. In other words, an operation position of the input operator may be detected based on a change in capacitance between the input operator and the first and second transparent electrode portions 21 and 22, or an operation position of the input operator may be detected based on a change in capacitance between the first and second transparent electrode portions 21 and 22. In the former case, a signal generation section for supplying an input signal (pulse signal or the like) to the first transparent electrode portion 21 and the second transparent electrode portion 22 is necessary, and in the latter case, a signal generation section for supplying an input signal (pulse signal or the like) to the first transparent electrode portion 21 or the second transparent electrode portion 22. The signal generation section may be included in the control unit 70 or provided separately from the control unit 70.

Action of Display Apparatus

In the display apparatus 1 of this embodiment formed as described above, since the touch panel 10 has the structure in which the first transparent electrode portions 21 and the second transparent electrode portions 22 are supported by the common transparent base material 11, it is possible to reduce the thickness of the touch panel as compared to the structure of related art in which two base materials on which transparent electrode portions are formed are bonded to each other. Accordingly, the reduction in thickness of the touch panel 10 can be realized.

Therefore, according to the display apparatus 1 of this embodiment, it is possible to reduce the thickness of the entire display apparatus 1 by reducing the thickness of the touch panel 10. Accordingly, it is possible to achieve a reduction in thickness and weight of an electronic apparatus including the display apparatus 1.

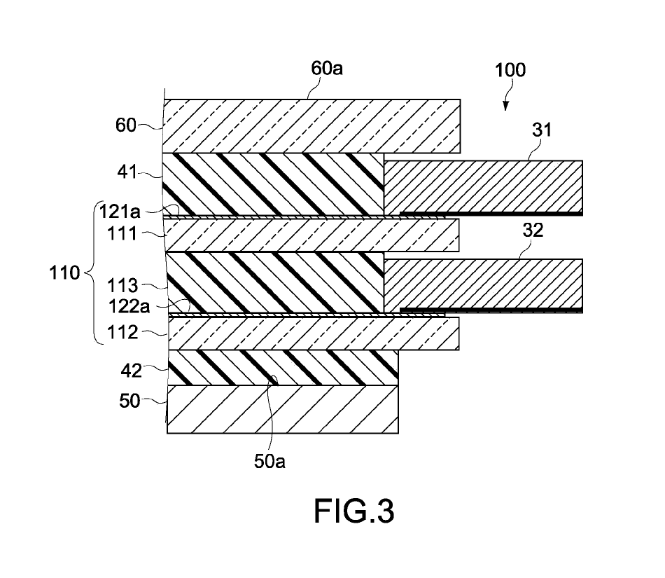

As a comparative example, a structure example of a touch panel including the structure in related art described above and a display apparatus including the touch panel is shown in FIG. 3. In FIG. 3, portions corresponding to those of FIG. 1 are denoted by the same reference symbols, and description thereof will be omitted. A display apparatus 100 shown in FIG. 3 includes a touch panel 110. The touch panel 110 includes an upper transparent base material 111 on which a first conductive pattern 121a is formed, a lower transparent base material 112 on which a second conductive pattern 122a is formed, and a transparent pressure-sensitive adhesive 113 that bonds both the transparent base materials 111 and 112 to each other. The touch panel 110 with such a structure needs the two upper and lower transparent base materials 111 and 112 and the transparent pressure-sensitive adhesive 113 that bonds those transparent base materials 111 and 112, which makes it difficult to reduce the thickness.

According to the touch panel 10 of this embodiment, the thickness of one transparent base material and that of the transparent pressure-sensitive adhesive 113 can be cut as compared to the touch panel 110 in related art, with the result that an effective reduction in thickness can be realized and simultaneously optical characteristics such as transmittance can be improved due to the reduced number of layers. Further, the step of bonding the base materials can be omitted, with the result that the productivity can be improved due to a reduction in man-hours for production. In addition, the step of bonding can be omitted, with the result that the alignment accuracy between two conductive patterns can be ensured, and the touch panel 10 having desired element characteristics can be stably manufactured.

On the other hand, the touch panel 110 in related art has the structure in which the wiring substrate 32 is sandwiched between the two transparent base materials 111 and 112. Therefore, there is a fear that a variation in thickness of the transparent pressure-sensitive adhesive 113 and the wiring substrate 32 causes a local curvature or deformation on the transparent base materials 111 and 112, which lowers the visibility of a display image. In addition, it is possible to avoid the above-mentioned problem by attaching the wiring substrate 32 to the lower transparent base material 112 via a notch formed at a peripheral portion of the upper transparent base material 111. However, the step of forming the notch is additionally necessary, and in addition, there is a fear that the durability of the touch panel is lowered because cracks are liable to be caused at a position at which the notch is formed.

On the other hand, in the touch panel 10 of this embodiment, the first and second wiring substrates 31 and 32 are attached to the front surface 11a and the back surface 11b of the transparent base material 11, respectively. Accordingly, the structure in which the wiring substrate is sandwiched between the transparent base materials can be done away with, with the result that the above-mentioned problem can be eliminated radically. Further, in the touch panel 10 of this embodiment, the first and second wiring substrates 31 and 32 are attached to the transparent base material 11 such that the respective terminal groups 31a and 32a are opposed to each other. Therefore, shield layers formed of conductor layers are provided on the surfaces of the first and second wiring substrates 31 and 32, which are different from the surfaces on which the terminal groups 31a and 32a are formed, with the result that electromagnetic noises can be prevented from being mixed and a touch panel having excellent detection accuracy can be formed.

Method of Manufacturing Touch Panel

Next, a method of manufacturing the touch panel 10 of this embodiment will be described. The method of manufacturing the touch panel 10 of this embodiment includes the step of forming a first conductive pattern (first transparent electrode portions 21 and first wire group 21a) on the front surface 11a of the transparent base material 11, and the step of forming a second conductive pattern (second transparent electrode portions 22 and second wire group 22a) on the back surface 11b of the transparent base material 11.

Before the respective conductive patterns are formed, the transparent base material 11 is subjected to annealing treatment. Examples of the annealing treatment for the transparent base material 11 include a method of continuously paying out and feeding a band-like base material wound in a roll form to an annealing furnace, and in addition thereto, a method of cutting a band-like base material into a predetermined size and then loading the individual base materials to the furnace is also included. The annealing treatment is performed mainly aiming at removing a residual stress of the transparent base material 11. At this time, the transparent base material 11 may be subjected to surface treatment for enhancing the adhesiveness with conductor films.

Next, on the front surface of the transparent base material 11, the first conductive pattern including the first transparent electrode portions 21 and the first wire group 21a is formed. The first transparent electrode portions 21 may be obtained by forming an ITO film on the front surface of the transparent base material 11 and then patterning (etching) the ITO film into a predetermined shape, or may be obtained by forming an ITO film, with a resist pattern formed on the front surface as a mask. For the formation of the first wire group 21a, various printing methods such as screen printing can be used. At a time when the first conductive pattern is formed, a protective sheet is attached to the back surface 11b of the transparent base material 11, with the result that the back surface 11b can be protected.

After the first conductive pattern is formed, a pressure-sensitive adhesive sheet is attached to the front surface 11a of the transparent base material 11. The pressure-sensitive adhesive sheet corresponds to the transparent pressure-sensitive adhesive 41 descried with reference to FIG. 1, and is to be laminated on the top plate 60 when a separator (protective film) laminated on the surface thereof is peeled off in a subsequent step.

Next, the protective sheet is peeled off from the back surface 11b of the transparent base material 11, and the second conductive pattern including the second transparent electrode portions 22 and the second wire group 22a is formed on the back surface 11b. The second conductive pattern is formed in the same manner as in the first conductive pattern described above. After the second conductive pattern is formed, a pressure-sensitive adhesive sheet is attached to the back surface 11b of the transparent base material 11. This pressure-sensitive adhesive sheet corresponds to the transparent pressure-sensitive adhesive 42 described with reference to FIG. 1, and is to be laminated on the display surface 50a of the display panel 50 when a separator (protective film) laminated on the surface thereof is peeled off in a subsequent step.

According to this embodiment as described above, the step of bonding transparent base materials to each other, which is indispensable in the manufacturing of the touch panel 110 of related art, is unnecessary, with the result that the productivity of the touch panel can be improved.

### SECOND EMBODIMENT

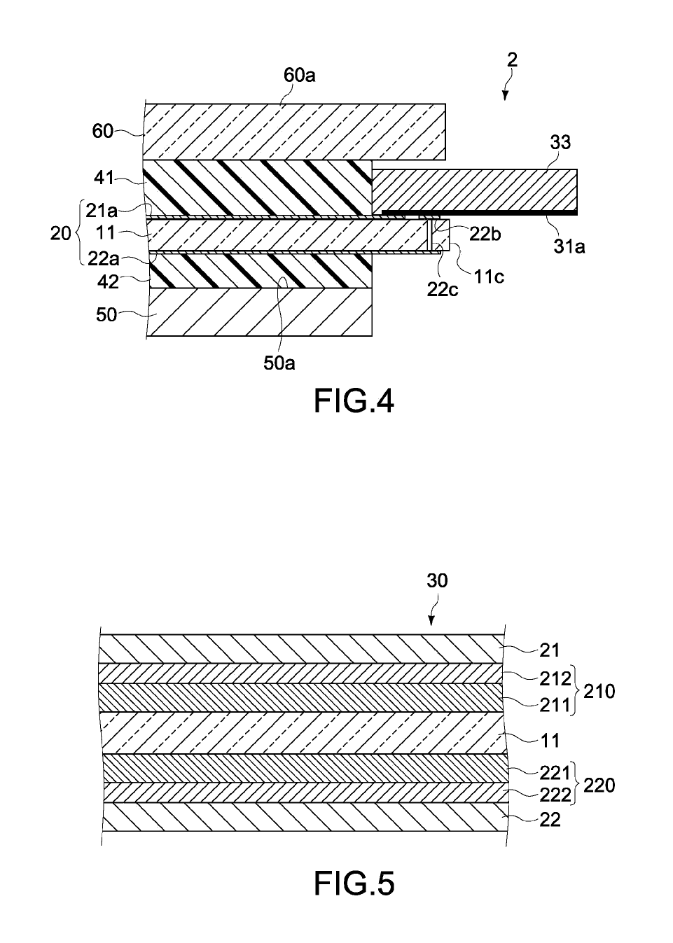

FIG. 4 is a cross-sectional view schematically showing a display apparatus according to a second embodiment. In FIG. 4, portions corresponding to those in FIG. 1 are denoted by the same reference symbols, and detailed description thereof will be omitted.

A display apparatus 2 of this embodiment is different from the first embodiment described above in the structure of the touch panel. A touch panel 20 of this embodiment includes a plurality of conductor portions 22b and interlayer connection portions 22c on the peripheral portion 11c side of the transparent base material 11. The conductor portions 22b are each formed on the front surface 11a of the transparent base material 11. The interlayer connection portions 22c each pass through the transparent base material 11, and electrically connect the second wire group 22a and the conductor portions 22b corresponding to the wires of the second wire group 22a. A wiring substrate 33 includes a terminal group electrically connected to the first wire group 21a and a terminal group electrically connected to the conductor portions 22b on the same plane.

According to the touch panel 20 of this embodiment, the conductive patterns on both the surfaces of the transparent base material 11 can be drawn to the outside by one wiring substrate 33. With this structure, as compared to the first embodiment described above, the entire thickness of the touch panel including the wiring substrate can be reduced. Further, the thickness of the display apparatus 2 including the touch panel 20 and that of an electronic apparatus including the display apparatus 2 can be further reduced. In addition, the touch panel 20 can be structured with one wiring substrate 33, with the result that the number of operations in the step of attaching the wiring substrate can be reduced, and the improvement in productivity and the reduction in manufacturing costs can be achieved.

### THIRD EMBODIMENT

Next, a third embodiment will be described with reference to FIG. 5. FIG. 5 is a cross-sectional view schematically showing a touch panel according to this embodiment. A touch panel 30 of this embodiment includes a first optical adjustment layer 210 and a second optical adjustment layer 220. The first optical adjustment layer 210 is formed between a transparent base material 11 and a first transparent electrode portion 21. The second optical adjustment layer 220 is formed between the transparent base material 11 and a second transparent electrode portion 22.

The first and second optical adjustment layers 210 and 220 each have a laminated structure of high-refractive-index films 211 and 221 and low-refractive-index films 212 and 222. The high-refractive-index films 211 and 221 and the low-refractive-index films 212 and 222 are each formed of an optically-clear metal oxide. In this embodiment, a niobium oxide (Nb₂O₅) film having a thickness of 10 nm (relative refractive index of 2.2 to 2.4) is used as the high-refractive-index films 211 and 221, and a silicon oxide (SiO₂) film having a thickness of 75 nm (relative refractive index of 1.4 to 1.6) is used as the low-refractive-index films 212 and 222, but materials and the number of laminated layers are not limited to the above example. The high-refractive-index films 211 and 221 are each arranged on the transparent base material 11 side, and the low-refractive-index films 212 and 222 are each arranged on the first and second transparent electrode portions 21 and 22 side.

Hard coat layers formed of a transparent resin may be formed between the transparent base material 11 and the first and second optical adjustment layers 210 and 220. The hard coat layer is formed aiming at improving the adhesiveness of the transparent base material 11 and the first and second optical adjustment layers 210 and 220, and maintaining the flatness of the transparent base material 11, and the like. The hard coat layer may be formed on both the surfaces of the transparent base material 11, or may be formed on any one of the surfaces.

The first and second optical adjustment layers 210 and 220 have a function of improving a transmittance of the touch panel in a visible light region. Accordingly, it is possible to improve an image quality of a display image that is visually identified from the top plate 60. Particularly according to this embodiment, since the touch panel is structured by forming the transparent electrode portions on both surfaces of one transparent base material 11, it is possible to further improve a transmittance as compared to the touch panel in related art (FIG. 3) that is structured by bonding two transparent base materials.

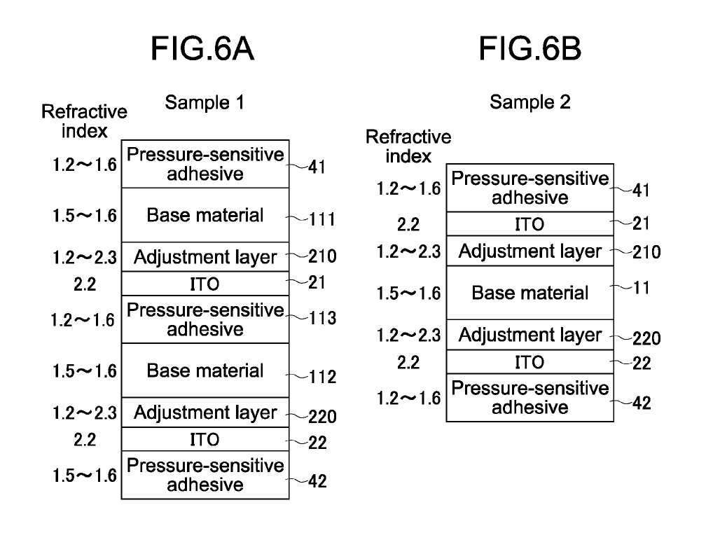

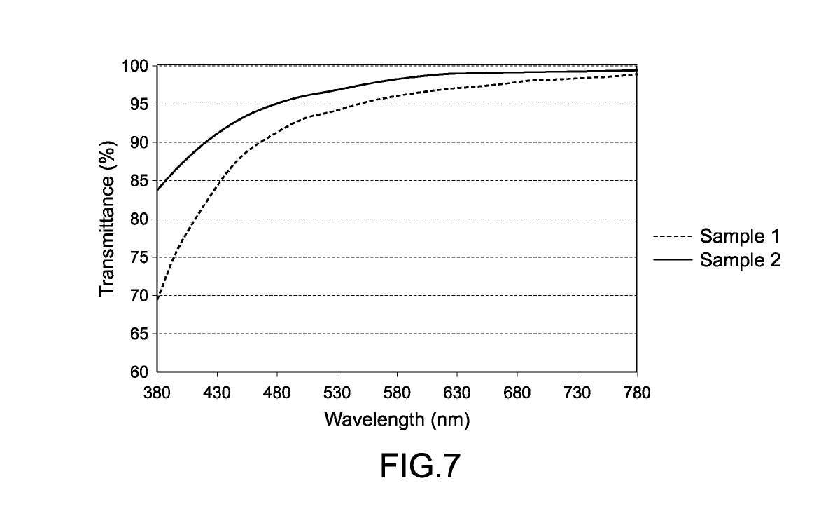

FIG. 6A shows a comparison of a transmittance characteristic of a touch panel (sample 1) in which two transparent base materials are bonded to each other (FIG. 3), with a transmittance characteristic of a touch panel (sample 2) in which transparent electrode portions are formed on both surfaces of one transparent base material (FIG. 1) as shown in FIG. 6B. Refractive-index conditions for the respective layers are as shown in FIG. 6. As a result, as shown in FIG. 7, it was confirmed that the sample 2 has a higher transmittance characteristic than that of the sample 1 over the entire visible light region.

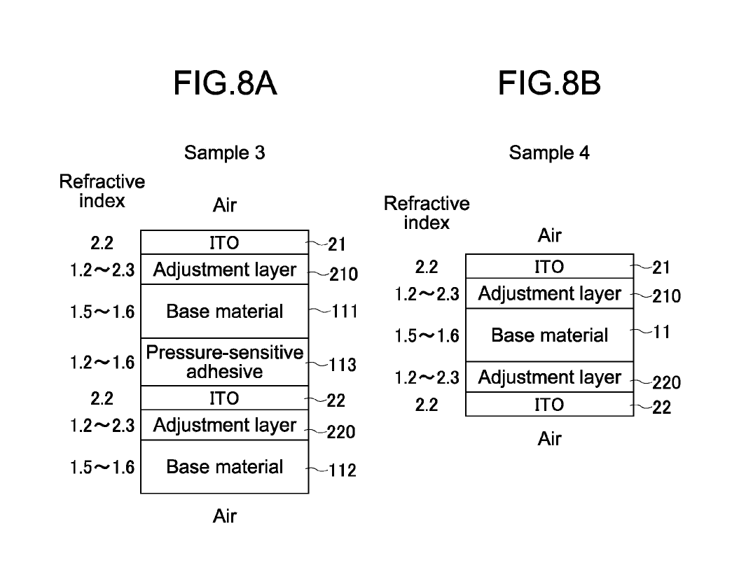

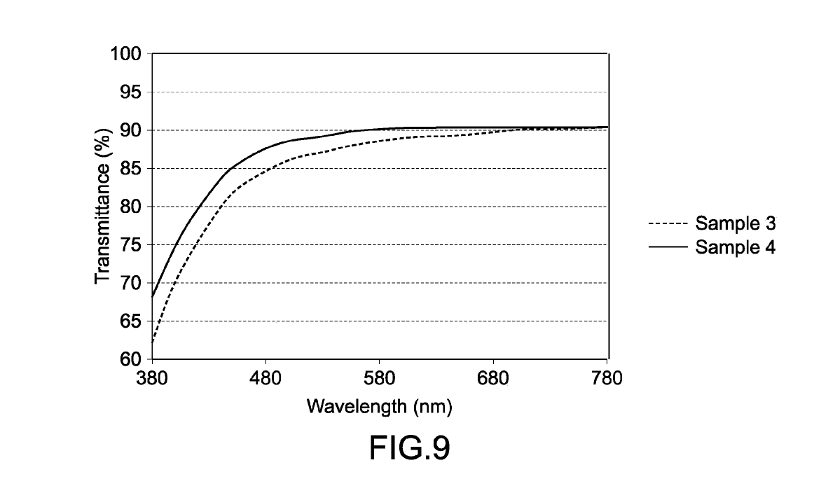

Evaluations were performed of transmittance characteristics similar to those above by using, as a sample 3 and a sample 4, the structures of the sample 1 and the sample 2 from each of which the transparent pressure-sensitive adhesives 41 and 42 serving as the uppermost layer and the lowermost layer are removed. The laminated structure and the transmittance characteristic of each of the sample 3 and the sample 4 are shown in FIG. 8 and FIG. 9. As shown in FIG. 9, it was confirmed that the sample 4 has a higher transmittance characteristic than that of the sample 3 over the entire visible light region. Further, the transmittances lower than the measurement results of FIG. 7 are considered to be derived from a reflection loss of light between the ITO layers 21 and 22 and an air layer (refractive index 1). Therefore, when a layer having a refractive index of a magnitude enough to mitigate the difference between the refractive indices of the touch panel and a layer laminated thereon (display panel 50, top plate 60, or the like) is used as the transparent pressure-sensitive adhesives 41 and 42, it is possible to provide a touch panel having a high transmittance characteristic.

Modified Examples

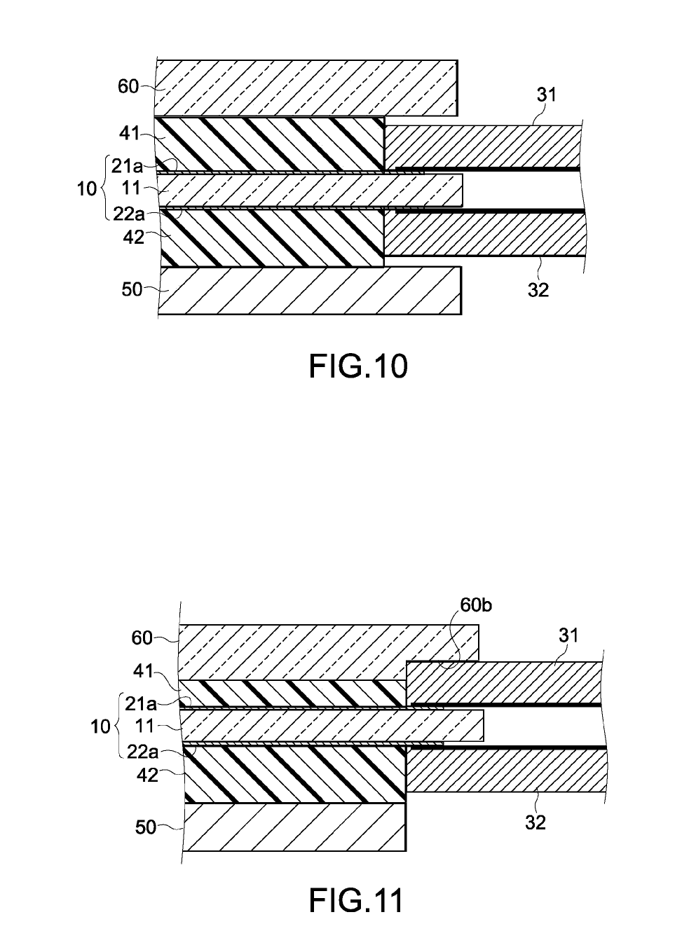

As shown in FIG. 10, the display panel 50 may be structured such that the first and second wiring substrates 31 and 32 of the touch panel 10 and the display panel 50 overlap each other when viewed from the thickness direction. Accordingly, an image display area of the display panel 50 can be largely formed.

Further, as shown in FIG. 11, the thickness of the transparent pressure-sensitive adhesive 41 formed between the touch panel 10 and the top plate 60 may be made smaller than that of the wiring substrate 31 attached to the front surface 11a of the transparent base material 11 of the touch panel 10. In this case, to avoid the interference between the top plate 60 and the wiring substrate 31, a recessed portion 60b may be formed on a back surface of the top plate 60 as shown in FIG. 11.

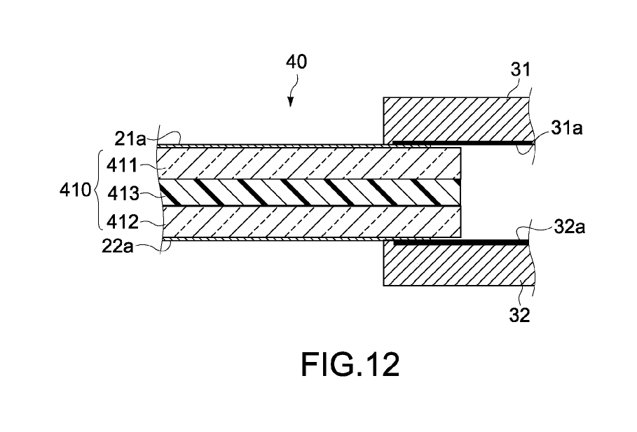

Further, in the embodiments, the transparent base material 11 of the touch panel is formed of a single-layer plastic film, but the present invention is not limited thereto. For example, a touch panel 40 shown in FIG. 12 includes a transparent base material 410 having a laminated structure in which a first transparent base material 411 and a second transparent base material 412 are bonded by a transparent pressure-sensitive adhesive 413. In this case, a first conductive pattern 21a is formed on the front surface of the first transparent base material 411, and a second conductive pattern 22a is formed on the back surface of the second transparent base material 412. Those conductive patterns 21a and 22a are formed after the transparent base material 411 is laminated. With this structure, it is unnecessary to ensure the alignment accuracy between the conductive patterns 21a and 22a at a time of bonding the base materials. As a result, it is possible to use a thin film enough to ensure the handleability at a time of bonding, as the transparent base materials 411 and 412.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A sensor element comprising:
a flexible transparent base material having a first surface and a second surface opposite to the first surface;
a first conductive pattern configured to electrostatically detect an operation position of an input operator in a first direction, the first conductive pattern being formed on the first surface; and
a second conductive pattern configured to electrostatically detect an operation position of the input operator in a second direction different from the first direction, the second conductive pattern being formed on the second surface.

2. The sensor element according to claim 1, wherein
the first conductive pattern includes a plurality of first transparent electrode portions that are extended in the second direction and arranged in the first direction, and
the second conductive pattern includes a plurality of second transparent electrode portions that are extended in the first direction and arranged in the second direction.

3. The sensor element according to claim 2, further comprising:
a first wiring substrate that is attached to the first surface and includes a first terminal group electrically connected to the first conductive pattern; and
a second wiring substrate that is attached to the second surface and includes a second terminal group electrically connected to the second conductive pattern.

4. The sensor element according to claim 2, further comprising:
a conductor portion formed on the first surface;
an interlayer connection portion configured to pass through the base material to connect the conductor portion and the second conductive pattern; and
a wiring substrate that is attached to the first surface and includes a first terminal group electrically connected to the first conductive pattern and a second terminal group electrically connected to the conductor portion.

5. The sensor element according to claim 1, further comprising
an optical adjustment layer having a laminated structure of a plurality of metal oxides each having a different refractive index, between the first surface and the first conductive pattern.

6. A display apparatus comprising:
a display panel having a display surface on which an image is displayed; and
a sensor element including
a flexible transparent base material having a first surface and a second surface opposite to the first surface,
a first conductive pattern configured to electrostatically detect an operation position of an input operator in a first direction, the first conductive pattern being formed on the first surface, and
a second conductive pattern configured to electrostatically detect an operation position of the input operator in a second direction different from the first direction, the second conductive pattern being formed on the second surface, the sensor element being laminated on the display panel such that the second surface and the display surface are opposed to each other.

7. The display apparatus according to claim 6, further comprising
a transparent substrate that is laminated on the first surface of the sensor element and forms an operation surface on which an input operation is made with the input operator.
